(19) United States
(12) Patent Application Publication
(10) Pub. No.: US 2010/0245811 A1
(43) Pub. Date: Sep. 30, 2010

(54) Inspecting apparatus and inspecting method

(75) Inventor: Toru Yoshikawa, Yokohama-shi (JP)

Correspondence Address: STAAS & HALSEY LLP, SUITE 700, 1201 NEW YORK AVENUE, N.W., WASHINGTON, DC, 20005, US

(73) Assignee: NIKON CORPORATION, Tokyo (JP)

(21) Appl. No.: 12/801,339

(22) Filed: Jun. 3, 2010

Related U.S. Application Data
(63) Continuation of application No. PCT/JP2008/071851, filed on Dec. 2, 2008.

(30) Foreign Application Priority Data
Dec. 6, 2007 (JP) 2007-316351

(51) Int. Cl. G01N 21/00

(52) U.S. Cl. 356/237.2

(57) ABSTRACT

An inspecting apparatus (1) obtains a pixel from among pixels of a DMD element (31) for guiding light from a wafer (W) to detecting elements (36a, 36b, 36c), based on luminance information on Fourier image obtained by detection by a two-dimensional imaging element (33) when the inspecting apparatus is set to guide all the light from the wafer (W) to the two-dimensional imaging element (33) by having all the pixels (micro mirrors) of the DMD element (31) in the on-state. Then, the inspecting device brings the obtained pixel of the DMD element (31) into the off-state, reflects a part of the light from the wafer (W) by the pixel in the off-state and guides the light to the detecting elements (36a, 36b, 36c).

This is a continuation of PCT International Application No. PCT/JP2008/071851, filed on Dec. 2, 2008, which is hereby incorporated by reference. This application also claims the benefit of Japanese Patent Application No. 2007-316351, filed in Japan on Dec. 6, 2007, which is hereby incorporated by reference.

### TECHNICAL FIELD

The present invention relates to an inspecting apparatus and an inspecting method for detecting a pattern formed on the surface of an inspection target substrate in the manufacturing steps of semiconductor elements, liquid crystal display elements and the like.

### TECHNICAL BACKGROUND

Various apparatuses to inspect defects, such as unevenness and scratches on the surface of a substrate, using reflected light generated from a pattern formed on the surface of the inspection target substrate, such as a semiconductor wafer and a liquid crystal glass substrate, have been proposed (e.g. see Patent Document 1). In particular during recent years, high accuracy is demanded in managing defects of inspection target substrates as the miniaturization of the semiconductor process progresses.

For example, in the case of measuring a pattern width of an inspection target substrate using an SEM, the measurement accuracy is high, but measurement takes enormous time since the viewing magnification is high and measurement is performed sampling several points. To avoid this, a method for irradiating light with a predetermined wavelength emitted from a light source onto a surface of the inspection target substrate by epi-illumination via a polarizer and an objective lens, and evaluating an image obtained by the reflected light from the inspection target substrate, which is generated by this illumination, via an objective lens and an analyzer, which satisfies the conditions of a “crossed Nicols” with a polarizer, has been proposed.

Patent Document 1: Japanese Laid-Open Patent Publication No. 2000-155099

### DISCLOSURE OF THE INVENTION

### Problems to be Solved by the Invention

With this method, however, the reflected light from the inspection target substrate is very weak, and a long exposure time is required to obtain an image, depending on the inspection target substrate.

### DISCLOSURE OF THE INVENTION

With the foregoing in view, it is an object of the present invention to provide an inspecting apparatus and inspecting method that allows inspection with high sensitivity at high-speed.

To achieve this object, an inspecting apparatus according to the present invention comprises: an illuminating section which irradiates illumination light onto a surface of an inspection target substrate; an optical path switching section which has a plurality of optical path switching elements and can switch respective reflecting directions of the plurality of optical path switching elements between one direction and another direction; a two-dimensional image sensor which can detect light from the inspection target substrate onto which the illumination light is irradiated, when the optical path switching elements are oriented in the one direction; an optical sensor which can detect light from the inspection target substrate onto which the illumination light is irradiated, when the optical path switching elements are oriented in the other direction; a control section which controls operation of the optical path switching section; and an inspecting section which inspects the surface of the inspection target substrate based on information obtained by the detection of the optical sensor, and the control section performs control of turning the optical path switching elements to the one direction to determine a part suitable for the inspection out of an inspecting region of the two-dimensional image sensor based on information obtained by the detection of the two-dimensional image sensor, and turning the optical path switching elements corresponding to the determined part suitable for the inspection, to the other direction, and the inspecting section performing the inspection based on information obtained by the detection of the optical sensor in a state where the optical path switching elements corresponding to the part suitable for the inspection are oriented in the other direction.

In the above mentioned inspecting apparatus, the illumination light is linearly polarized light which is irradiated onto the surface of the inspection target substrate having a repeat pattern, and the two-dimensional image sensor and the optical sensor detect a linearly polarized light component of which polarizing direction is approximately orthogonal to the linearly polarized light, out of the light from the inspection target substrate.

In this case, it is preferable that the illuminating section irradiates the illumination light onto the surface of the inspection target substrate by epi-illumination.

In the above inspecting apparatus, it is preferable that the information obtained by the detection of the two-dimensional image sensor is luminance information in a Fourier image obtained by the detection of the two-dimensional image sensor.

It is preferable that the above inspecting apparatus has a spectral prism which disperses light guided from the optical path switching elements to the optical sensor into a plurality of wavelengths, and the optical sensor is disposed for each of the plurality of wavelengths obtained by the dispersion by the spectral prism.

In the above inspecting apparatus, it is preferable that the plurality of optical path switching elements are a plurality of micro-mirrors constituting a digital micro-mirror device.

An inspecting method according to the present invention is an inspecting method for inspecting a surface of an inspection target substrate, using an inspecting apparatus which has: an illuminating section which irradiates illumination light onto the surface of the inspection target substrate; an optical path switching section which has a plurality of optical path switching elements, and can switch respective reflecting directions of the plurality of optical switching elements between one direction and another direction; a two-dimensional image sensor which can detect light from the inspection target substrate onto which the illumination light is irradiated, when the optical path switching elements are oriented in the one direction; and an optical sensor which can detect light from the inspection target substrate onto which the illumination light is irradiated, when the optical path switching elements are oriented in the other direction, the inspection method comprising: a first step of turning the optical path switching elements to the one direction to determine a part suitable for the inspection out of an inspecting region of the two-dimensional image sensor based on information obtained by the detection of the two-dimensional image sensor; and a second step of turning the optical path switching elements corresponding to the part suitable for the inspection, which is determined in the first step, to the other direction, and performing the inspection based on information obtained by the detection of the optical sensor.

In the above inspecting method, it is preferable that the illumination light is linearly polarized light which is irradiated onto the surface of the inspection target substrate having a repeat pattern, and the two-dimensional image sensor and the optical sensor detect a linearly polarized light component of which polarizing direction is approximately orthogonal to the linearly polarized light, out of the light from the inspection target substrate.

In this case, it is preferable that the illumination light is irradiated onto the surface of the inspection target substrate by epi-illumination.

In the above inspecting method, it is preferable that the information obtained by the detection of the two-dimensional image sensor is luminance information in a Fourier image obtained by the detection of the two-dimensional image sensor.

In the above inspecting method, it is preferable that in the first step, a part, in which the luminance change of the detected light based on the change of a surface state of the inspection target substrate is large, is determined as the part suitable for the inspection.

In the above mentioned inspecting method, it is preferable that the second step has a sub-step of dispersing light guided from the optical path switching elements to the optical sensor into a plurality of wavelengths, and the optical sensor detects light at each of the plurality of wavelengths obtained by the dispersion in the sub-step.

In the above mentioned inspecting method, it is preferable that the plurality of optical path switching elements are a plurality of micro-mirrors constituting a digital micro-mirror device.

An inspecting apparatus according to a second aspect of the invention has: an illuminating section which irradiates illumination light onto a surface of an inspection target substrate; a two-dimensional image sensor which can detect a Fourier image of the inspection target substrate onto which the illumination light is irradiated; a selective detecting section which detects luminance of a part of the Fourier image, and does not detect luminance of the other parts thereof; a control section which controls operation of the selective detecting section; and an inspecting section which inspects the surface of the inspection target substrate based on information obtained by the detection of the selective detecting section, and the control section selects the part to be detected by the selective detecting section based on the information of the Fourier image obtained by the detection of the two-dimensional image sensor.

### ADVANTAGEOUS EFFECTS OF THE INVENTION

According to the present invention, the inspection can be performed with high sensitivity at high-speed.

### BRIEF DESCRIPTION OF TI DRAWINGS

FIG. 1 is a schematic diagram depicting an inspecting apparatus according to the present invention;

FIG. 2 is a diagram depicting a relationship between an incident angle of the illumination light to a wafer and an image formation position in a pupil;

FIG. 3 is a flow chart depicting a method for creating a pixel correspondence table between a two-dimensional imaging element and a DMD element;

FIG. 4 is a flow chart depicting a method for determining a region having high sensitivity to a change of pattern;

FIG. 5 is a flow chart depicting a method for detecting a change of pattern with high sensitivity at high-speed;

FIG. 6 is a diagram depicting an example of a state of the divided region of a Fourier image;

FIG. 7 is a diagram depicting an extracting state of luminance data;

FIG. 8 is a diagram depicting a gradation difference distribution state of R in the Fourier image;

FIG. 9 is a diagram depicting a gradation difference distribution state of G in the Fourier image;

FIG. 10 is a diagram depicting a gradation difference distribution state of B in the Fourier image;

FIG. 11 is a schematic diagram depicting a variant form of the inspecting apparatus; and

FIG. 12 is a flow chart depicting a variant form of the method for determining a region having high sensitivity.

### EXPLANATION OF NUMERALS AND CHARACTERS

W wafer (inspection target object)
1 inspecting apparatus
10 illumination optical system (illuminating section)
17 polarizer
20 detection optical system
21 analyzer
30 imaging section
31 DMD element (optical path switching element)
33 two-dimensional imaging element (two-dimensional image sensor)
35 spectral prism
36a first detecting element (optical sensor)
36b second detecting element (optical sensor)
36c third detecting element (optical sensor)
40 control unit
43 CPU (e.g. control section)

### DESCRIPTION OF THE PREFERRED EMBODIMENTS

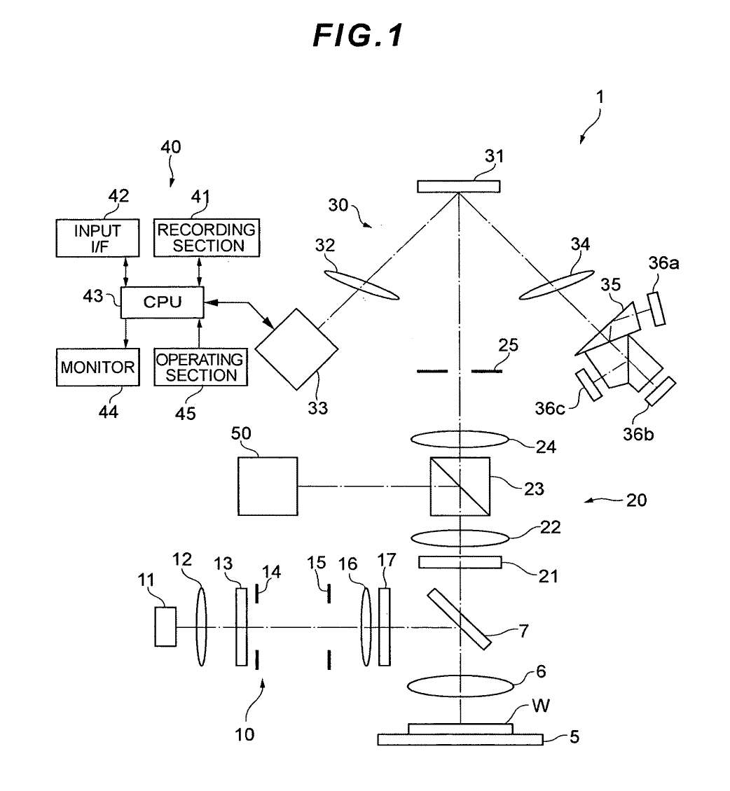

Preferred embodiments of the present invention will now be described with reference to the drawings. FIG. 1 shows an inspecting apparatus according to the present invention. The inspecting apparatus 1 of the present embodiment comprises, as shown in FIG. 1, a wafer stage 5, an objective lens (×100) 6, a half mirror 7, an illumination optical system 10, an inspection optical system 20, an imaging section 30 and a control unit 40.

A semiconductor wafer W (hereafter called “wafer W”), which is an inspection target substrate, is set on the wafer stage 5 in a state of the pattern (repeat pattern) surface facing up. This wafer stage 5 is constructed to be able to move in three direction, that is x, y and z axes, which are perpendicular to one another (the vertical direction in FIG. 1 is regarded as the z axis direction). Therefore the wafer stage 5 can support and move the wafer W in the x, y and z axes directions. The wafer stage 5 can also rotate around the z axis.

The illumination optical system 10 is comprised of, in order from left to right in FIG. 1, a light source 11 (e.g. white LED, halogen lamp), a collective lens 12, an illuminance uniforming unit 13, an aperture stop 14, a field stop 15, a collimator lens 16, and a removable polarizer 17 (polarizing filter).

The light emitted from the light source 11 of the illumination optical system 10 is guided to the aperture stop 14 and the field stop 15 via the collective lens 12 and the luminance uniforming unit 13. The illuminance uniforming unit 13 scatters the illumination light so as to make the distribution of quantity of light uniform. An interference filter may be included. The aperture stop 14 and the field stop 15 are constructed so that the size and position of the aperture portion can be changed with respect to the optical axis of the illumination optical system 10. Therefore in the illumination optical system 10, the size and position of the illuminating region can be changed, and the angular aperture of the illumination can be adjusted by the operation of the aperture stop 14 and the field stop 15. The light which passed through the aperture stop 14 and the field stop 15 is collimated by the collimator lens 16, and enters the half mirror 7 via the polarizer 17.

The half mirror 7 reflects the light from the illumination optical system 10 downward, so as to guide it to the objective lens 6. Thereby the wafer W is epi-illuminated by the light from the illumination optical system 10 which passed the objective lens 6. The light that epi-illuminated onto the wafer W is reflected by the wafer W, and can return to the object lens 6 again, transmit through the half mirror 7, and enter the detection optical system 20.

The detection optical system 20 is comprised of, in order from the bottom to top in FIG. 1, a removable analyzer 21 (polarizing filter), a lens 22, a half prism 23, a Bertrand lens 24, and a field stop 25. The analyzer 21 is disposed to form a crossed Nicols state (state of polarizing directions crossing) with the polarizer 17 of the illumination optical system 10. Since the polarizer 17 of the illumination optical system 10 and the analyzer 21 of the detection optical system 20 satisfies the conditions of crossed Nicols, a quantity of light detected in the detection optical system 20 is close to zero, unless the principal axis of the polarizing does not rotate in the pattern on the wafer W.

The half prism 23 splits the incident luminous flux into two directions. One luminous flux, which passes through the half prism 23, forms an image of the wafer W on the field stop 25 via the Bertrand lens 24, and projects the image of the pupil surface of the objective lens 6 on the DMD (Digital Micro-mirror Device) element 31 of the imaging section 30. Since the two-dimensional imaging element 33 of the imaging section 30 is conjugate with the DMD element 31, the luminance distribution on the pupil surface of the objective lens 6 is reproduced on the imaging plane of the two-dimensional imaging element 33, and the image (Fourier image) of the wafer W, which was Fourier-transformed by the two-dimensional imaging element 33, can be picked up. The field stop 25 can change the shape of the aperture on the plane vertical to the optical axis of the detection optical system 20. Therefore the two-dimensional imaging element 33 can detect information on any region of the wafer W by the operation of the field stop 25. The other luminous flux which passes through the half prism 23 is guided to the second imaging section 50 for picking up an image which is not Fourier-transformed.

The reason why the Fourier image (that is, an image of the pupil surface of the objective lens 6) is picked up in the defect inspection of the present embodiment is as follows. If an image, when the pattern of the wafer W is directly picked up, is used in defect inspection, then the defect of the pattern cannot be optically detected if the pitch of the pattern is less than the resolution of the inspecting apparatus. In the case of a Fourier image, on the other hand, if a defect exists in a pattern of the wafer W, the symmetry of reflected lights is lost, and luminance and color between the portions perpendicular to the optical axis of the Fourier image change because of the structural double refraction. Hence even if the pitch of the pattern is less than the resolution of the inspecting apparatus, a defect in the pattern can be detected if the above mentioned change in the Fourier image is detected.

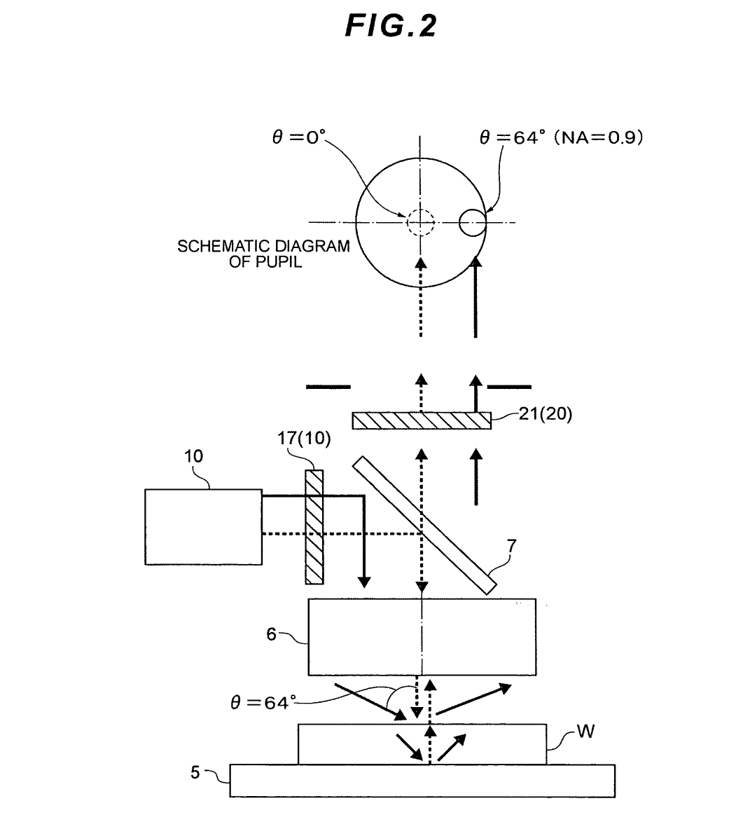

Now the relationship between an incident angle of the illumination light to the wafer W and the image forming position in the pupil surface will be described with reference to FIG. 2. As the broken line in FIG. 2 shows, when the incident angle of the illumination light to the wafer W is 0°, the image forming position on the pupil is the center of the pupil. When the incident angle is 64° (equivalent to NA=0.9), on the other hand, the image forming position on the pupil is the outer edge of the pupil, as the solid line in FIG. 2 shows. In other words, on the pupil, the incident angle of the illumination light to the wafer W depends on the position in the radius direction of the pupil. The lights which form the images in positions within a same radius from the optical axis in the pupil are lights which entered the wafer W at a same angle.

The imaging section 30 is comprised of a DMD (Digital Micro-mirror Device) element 31, a lens 32, a two-dimensional imaging element 33, a lens 34 disposed at the opposite side, a spectral prism 35, and three detecting elements: 36a, 36b and 36c. The DMD element 31 has a plurality of movable micro-mirrors (not illustrated) arranged on a plane. The micro-mirror of the DMD element 31 is driven by electricity, and tilts so that the light from the detection optical system 20 is reflected to the two-dimensional imaging element 31 in the ON state, and tilts so that the light from the detection optical system 20 is reflected to the detecting elements 36a, 36b and 36c (spectral prism 35) in the OFF state.

Therefore the light from the detection optical system 20 reflected by the micro-mirror in the ON state passes through the lens 32 (gate optical system) and is guided to the imaging plane of the two-dimensional imaging element 33. The light from the detection optical system 20 reflected by the micro-mirror in the OFF state, on the other hand, passes through the lens 34 (gate optical system) and is dispersed into R (red), G (green) and B (blue) lights by the spectral prism 35, and is then guided to the three detecting elements: 36a, 36b and 36c.

The two-dimensional imaging element 33 is a CCD or CMOS, for example, which has a color filter array with a Bayer arrangement, and picks up the above mentioned Fourier image. The three detecting elements 36a, 36b and 36c are photodiodes, avalanche elements or the like, and detect R (red), G (green) and B (blue) lights obtained by the dispersion by the spectral prism 35 respectively.

The control unit 40 is comprised of a recording section 41 which records data on the Fourier image, an input interface 42, a CPU 43 which executes various computing processings, a monitor 44 and operating section 45, and executes comprehensive control of the inspecting apparatus 1. The recording section 41, input interface 42, monitor 44 and operating section 45 are electrically connected with the CPU 43 respectively. The CPU 43 analyzes the Fourier image by executing programs, and determines a region having high sensitivity to the change of patterns in the Fourier image picked up by the two-dimensional imaging element 33. The input interface 42 has a connector to connect a recording media (not illustrated) and a connection terminal to be connected with an external computer (not illustrated), and reads data from the recording media or the computer.

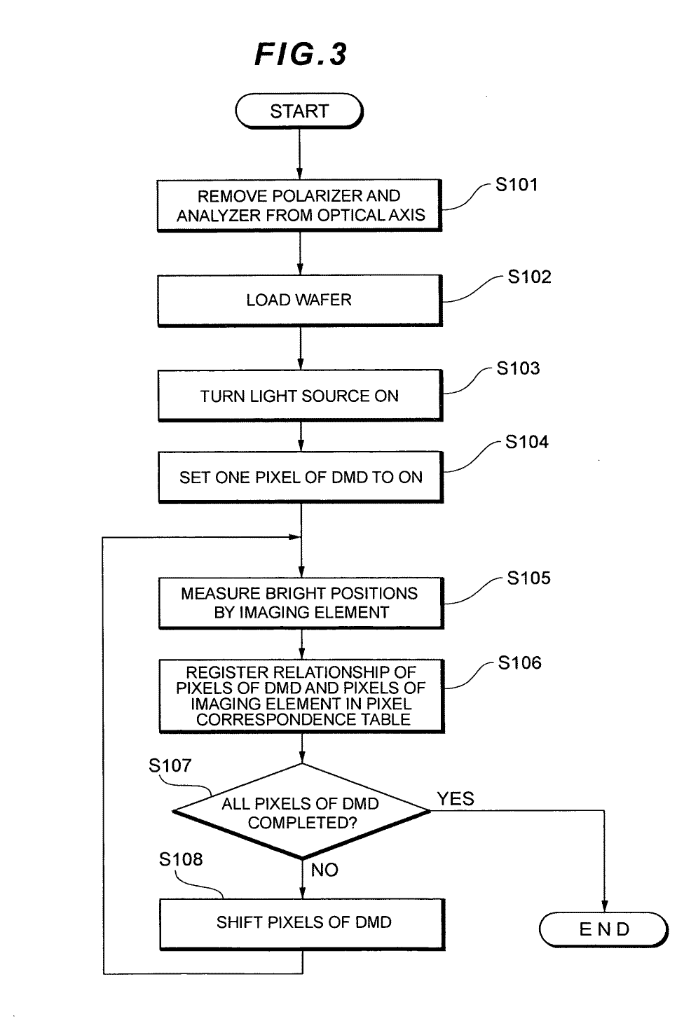

A method for inspecting a wafer W using the inspecting apparatus 1 having the above configuration will now be described with reference to the flow charts shown in FIG. 3 to FIG. 5. First a method for creating a pixel correspondence table between the two-dimensional imaging element 33 and the DMD element 31 will be described using the flow chart shown in FIG. 3. According to the method for creating the pixel correspondence table, the polarizer 17 of the illumination optical system 10 and the analyzer 21 of the detection optical system 20 are removed from the optical axis in step S101. Then in step S102, the wafer W, without patterns, is moved to a position below the objective lens 6 (monitoring position) by the wafer stage 5.

In the next step S103, the light source 11 of the illumination optical system 10 is turned ON. The illumination light emitted from the light source 11 passes through the aperture stop 14 and the field stop 15 via the collective lens 12 and the illuminance uniforming unit 13, collimated by the collimator lens 16, reflected by the half mirror 7, and then is irradiated onto the wafer W via the objective lens 6. The reflected light from the wafer W passes through the objective lens 6 and the half mirror 7, and enters the detection optical system 20, and the light which entered the detection optical system 20 passes through the lens 22, half prism 23, Bertrand lens 24 and field stop 25, and the Fourier image is projected onto the DMD element 31 of the imaging section 30.

In the next step S104, only one pixel (micro-mirror) of the DMD element 31 is set to the ON state, and the other pixels (micro-mirrors) are set to the OFF state. Then the light from the detection optical system 20, reflected by the pixel in the ON state, passes through the lens 32, and is guided to the imaging plane of the two-dimensional imaging element 33.

In the next step S105, an image is picked up by the two-dimensional imaging element 33, and detects the light reflected by the pixel (micro-mirror) in the ON state, and the CPU 43 calculates the pixel position of the light reflected by the pixel in the ON state, on the imaging plane (two-dimensional imaging element 33).

In the next step S106, the CPU 43 registers the relationship between the pixel position of the two-dimensional imaging element 33 determined in step S105, and the pixel (micro-mirror) position of the DMD element 31 in this time in the pixel correspondence table of the recording section 41.

In the next step S107, the CPU 43 determines whether measurement is completed for all the pixels of the DMD element 31. If the result is YES, creation of the pixel correspondence table is completed, and if the result is NO, processing advances to step S108.

In step S108, the pixel (micro-mirror) to be set to the ON state of the DMD element 31 is changed to a pixel which has not yet been measured, and processing returns to step S105. By this sequence, the relationship between the pixel of the two-dimensional imaging element 33 and the pixel of the DMD element 31 can be registered in the pixel correspondence table.

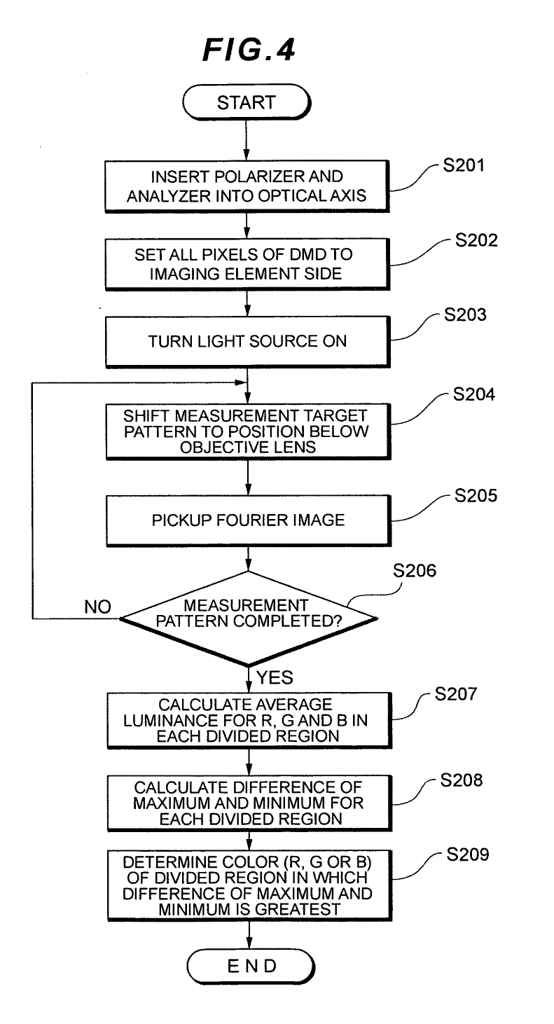

Now a method for determining a region having high sensitivity to a change of patterns in the Fourier image picked up by the two-dimensional imaging element 33 will be described using the flow chart shown in FIG. 4. According to the method for determining a region having high sensitivity, the polarizer 17 of the illumination optical system 10 and the analyzer 21 of the detection optical system 20 are inserted into the optical axis in step S201. Then in step S202, all the pixels (micro-mirrors) of the DMD element 31 are set to the ON state, so that all the lights from the wafer W are reflected to the two-dimensional imaging element 33. In the next step, S203, the light source 11 of the illumination optical system 10 is turned ON.

In the next step, S204, a waver W, on which the repeat pattern is formed, is set on the wafer stage 5, and a measurement target pattern (a part of one shot) on the wafer W is moved to a position below the objective lens 6 by the wafer stage 5. At this time, on a wafer W to be used, a plurality of patterns having a same shape but different exposure conditions (dosage and focus) respectively are formed.

Then the illumination light emitted from the light source 11 passes through the aperture stop 14 and the field stop 15 via the collective lens 12 and the illuminance uniforming unit 13, collimated by the collimator lens 16, and passes through the polarizer 17, reflected by the half mirror 7, then irradiated onto the wafer W via the objective lens 6. The reflected light from the wafer W passes through the objective lens 6 and the half mirror 7, and enters the detection optical system 20, and the light which entered the detection optical system 20 passes through the analyzer 21, lens 22, half prism 23, Bertrand lens 24 and field stop 25, and the Fourier image is projected onto the DMD element 31 of the imaging section 30. At this time, all the pixels (micro-mirrors) of the DMD element 31 are in the ON state, so the light reflected by the DMD element 31 passes through the lens 32, and the Fourier image is projected onto the imaging plane of the two-dimensional imaging element 33.

Then in the next step, S205, the Fourier image is picked up by the two-dimensional imaging element 33, and the picked-up-Fourier image is recorded in the recording section 41.

In the next step, S206, the CPU 43 determines whether measurement is completed for all the necessary patterns on the wafer W. If the result is YES, processing advances to step S207, and if the result is NO, processing returns to step S204, and a pattern (another shot), which has not yet been measured, is moved to a position below the objective lens 6, and the image is picked up in step S205. Accordingly, color data on a plurality of Fourier images having a same shape pattern but different exposure conditions respectively are recorded in the recording section 41.

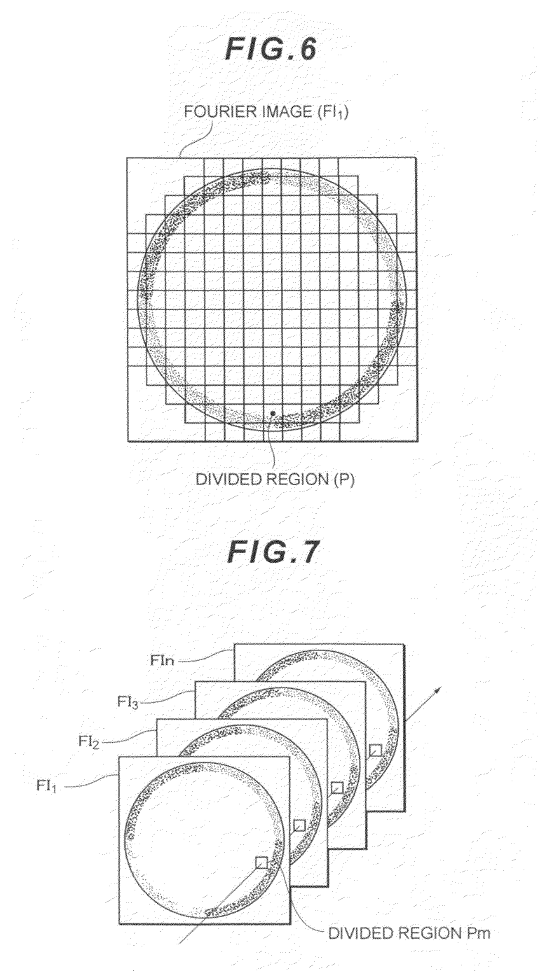

In step S207, the CPU 43 generates the luminance data (average value) of R (red), G (green) and B (blue) respectively for each position of each Fourier image. To determine the luminance data, a Fourier image (e.g. Fourier image FI₁ in the first frame) is parted into a plurality of square divided regions P which have the same vertical and horizontal sizes and are arranged in a lattice as shown in FIG. 6, and the average of the luminance value of R, G and B is determined respectively for each divided region P of the Fourier image. This step is then performed for each Fourier image. As a result, luminance data which indicates the gradation of each color component, R, G and B, in each divided region P of each Fourier image is generated respectively for the first frame to the nth frame of the Fourier images FI₁ to FIₙ.

In the next step, S208, focusing on a same divided region as shown in FIG. 7, the CPU 43 generates gradation difference data, which indicates the gradation difference among Fourier images FI₁ to FIₙ in the same divided region, for each color component of R, G and B. In concrete terms, when an arbitrary divided region on the Fourier image FI is assumed to be Pₘ, the luminance data of each color component in the divided region Pₘ (determined in step S207) is extracted from each Fourier image FI₁ to FIₙ respectively. Then the maximum value and the minimum value are extracted out of the gradation values of luminance data corresponding to the divided region Pₘ for each color component R, G and B, and calculates the difference value between the extracted maximum value and minimum value. This process is performed for all the divided regions. As a result, the gradation difference data (difference value of the maximum value and the minimum value of gradation), which indicates the gradation difference among Fourier images in the divided region Pₘ, is generated for each color component of R, G and B in all the divided regions of the Fourier image.

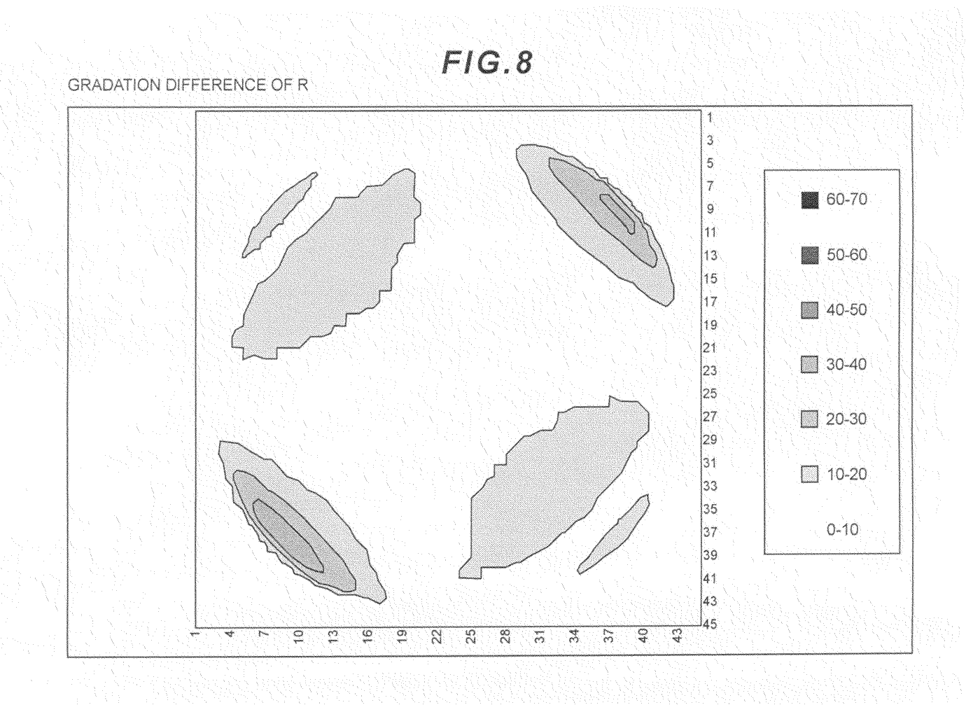

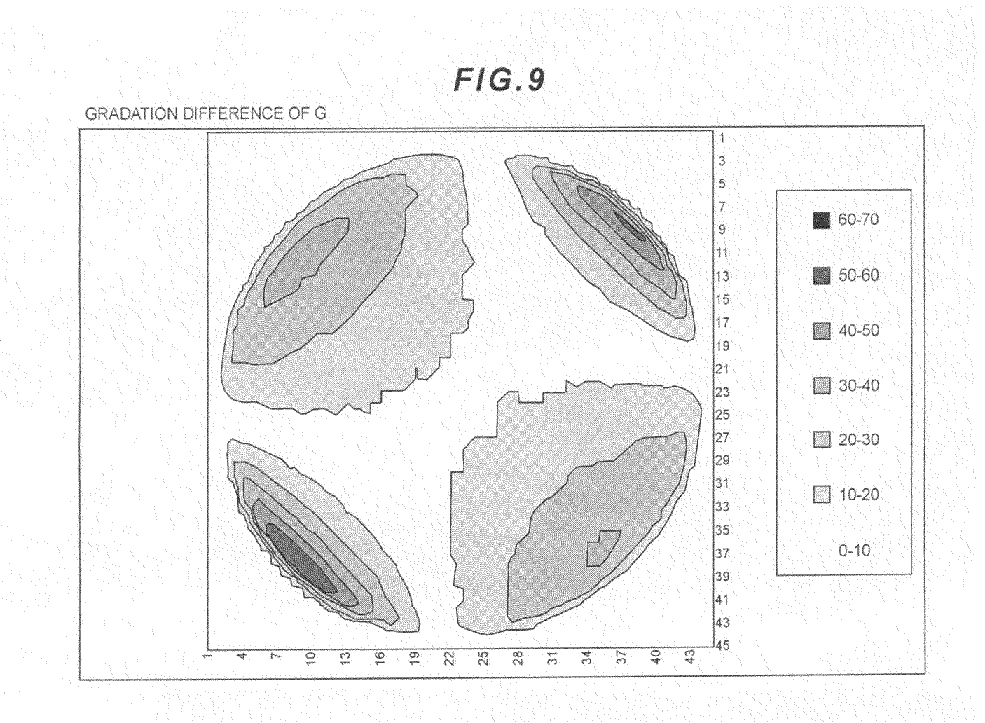

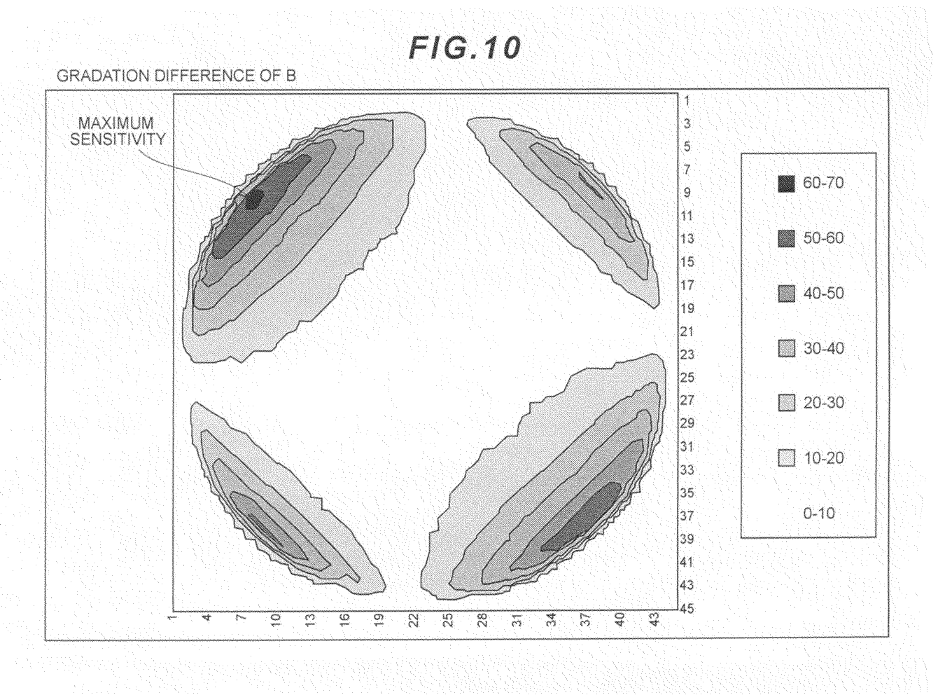

Then in step S209, the CPU 43 determines a color and the divided region in which the difference value between the maximum value and the minimum value of the gradation is maximum, out of the divided regions of the Fourier image, based on the gradation difference data (difference value of the maximum value and the minimum value of gradation) determined in step S208, determines this divided region as a region having a high sensitivity, and determines this as the detecting condition. FIG. 8 to FIG. 10 are diagrams depicting a gradation difference distribution state in each divided region of the Fourier image, shown for each color component. In the examples in FIG. 8 to FIG. 10, the upper left region with gradation difference B shown in FIG. 10 is the area having maximum sensitivity. Thus it can be determined which color of R, G or B should be used and which divided region in the Fourier image should be used in order to detect the change of the line width of the pattern, and the change of the profile with high sensitivity.

As described above, the change of an unknown pattern can be detected based on the image picked up by the two-dimensional imaging element 33. However in some cases, the reflected image from the wafer W is so weak that the exposure time of the two-dimensional imaging element 33 becomes too long, and throughput does not increase.

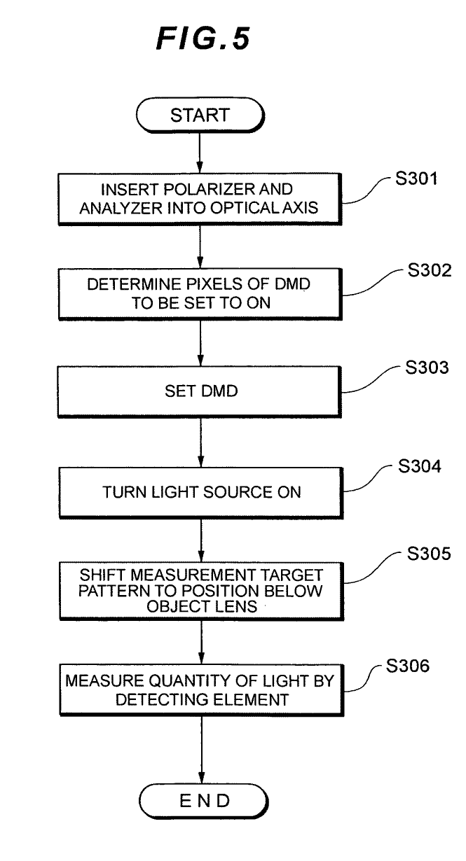

Therefore a method for detecting a change of pattern with high sensitivity and at high-speed will be described with reference to the flow chart in FIG. 5. According to the method for detecting this pattern, the polarizer 17 of the illumination optical system 10 and the analyzer 21 of the detection optical system 20 are inserted into the optical axis in step S301.

Then in step S302, the CPU 43 determines a pixel (micro-mirror) of the DMD element 31 to be turned ON/OFF in order to guide the reflected light from the wafer W to each detecting element 36a, 36b and 36c. In concrete terms, the CPU 43 determines a pixel of the DMD element 31 corresponding to a pixel region (divided region) having high sensitivity on the two-dimensional imaging element 33 determined in steps S201 to S209, with reference to the pixel correspondence table between the two-dimensional imaging element 33 and the DMD element 31 determined in steps S101 to 5108.

In the next step S303, the CPU 43 sets the pixel of the DMD element 31 corresponding to the pixel region (divided region) having high sensitivity determined in step S302 to the OFF state, so as to guide the reflected light for the wafer W to each detecting element 36a, 36b and 36c, and sets the other pixels to the ON state, so as to guide it to the two-dimensional imaging element 33.

In the next step, S304, the light source 11 of the illumination optical system 10 is turned ON. And in the next step S305, the inspection target wafer W is set on the wafer stage 5, and an inspection target pattern (for one shot) on the wafer W is moved to a position below the objective lens 6 by the wafer stage 5.

Then the illumination light emitted from the light source 11 passes through the aperture stop 14 and the field stop 15 via the collective lens 12 and the illuminance uniforming unit 13, collimated by the collimator lens 16, passes through the polarizer 17, reflected by the half mirror 7 and is irradiated onto the wafer W via the objective lens 6. The reflected light from the wafer W passes through the objective lens 6 and the half mirror 7 and enters the detection optical system 20, and the light which entered the detection optical system 20 passes through the analyzer 21, lens 22, half prism 23, Bertrand lens 24 and field stop 25, and reaches the Db element 31 of the imaging section 30. At this time, the reflected light from a region having high sensitivity to the change of patterns on the wafer is reflected by the pixel (micro-mirror) in the OFF state in the DMD element 31, and passes through the lens 34, and by the spectral prism 35, the red light is guided to the first detecting element 36a, the green light is guided to the second detecting element 36b, and the blue light is guided to the third detecting element 36c.

Then in step S306, the CPU 43 detects reflected light having high sensitivity, which is guided from the DMD element 31 by each detecting element 36a, 36b and 36c, measures the luminance (quantity of light) of the reflected light based on the detected signal, and detects the change of the pattern on the wafer W (that is, defect of the pattern) (based on the change of luminance). By using a photodiode, avalanche element or the like for each detecting element 36a, 36b and 36c, as mentioned above, the weak signal according to the reflected light from the wafer W can be converted into an electric signal (detecting signal) at high-speed (several MB with an avalanche element, while about 100 MB in the case of a CCD), and the state (change) of the pattern on the wafer W can be detected at high-speed. In the examples in FIG. 8 to FIG. 10, blue light detected by the third detecting element 36c is used. The pixel (micro-mirror) of the DMD element 31 is set to guide the reflected light from the wafer W to each detecting element 36a, 36b and 36c in the OFF state, even if positional accuracy is higher in the ON state, but if a reducing lens is used for the lens 34, the shift generated in the reflecting direction in the OFF state can be confined to the tolerance.

Thus according to the present embodiment, the two-dimensional imaging element 33, which can detect two-dimensional luminance information (position) at high precision, each detecting element 36a, 36b and 36c which can detect light (luminance information) at high-speed, and DMD element 31, are used in combination, whereby a pattern formed on the surface of the wafer W can be inspected with high sensitivity at high-speed, under optimum conditions for each step of the wafer manufacturing process.

In this case, if the two-dimensional imaging element 33 and each detecting element 36a, 36b and 36c detect linearly polarized light components of which polarizing direction is approximately perpendicular to the illumination light, which is linearly polarized light, out of the light from the wafer W, then the so called “crossed Nicol” state is generated, and inspection with high sensitivity utilizing structural double refraction can be performed. The polarizing directions of the polarizer 17 and the analyzer 21 are not limited to those forming 90° (crossed Nicol state), but may be finely adjusted according to the rotation of the elliptically polarized light due to the structural double refraction, generated in the inspection target pattern.

Also in this case, the size of the apparatus can be reduced by irradiating the surface of the wafer W by epi-illumination.

As described above, it is preferable that the two-dimensional luminance information obtained by the two-dimensional imaging element 33 is the luminance information on the Fourier image, since the defects of a pattern can be detected even if the pitch of the pattern is less than the resolution of the inspecting apparatus.

Also as described above, it is preferable that each detecting element 36a, 36b and 36c are disposed for each of the plurality of wavelengths (that is, red, green and blue light) dispersed by the spectral prism 35, then a region having high sensitivity can be detected for each wavelength, so as to implement inspection with higher sensitivity.

As the optical path switching element for switching the traveling direction of light from the wafer W, it is preferable to use a DMD element 31 having a plurality of micro-mirrors, because the direction of the traveling direction of light from the wafer W can be switched for each micro-region in pixel units.

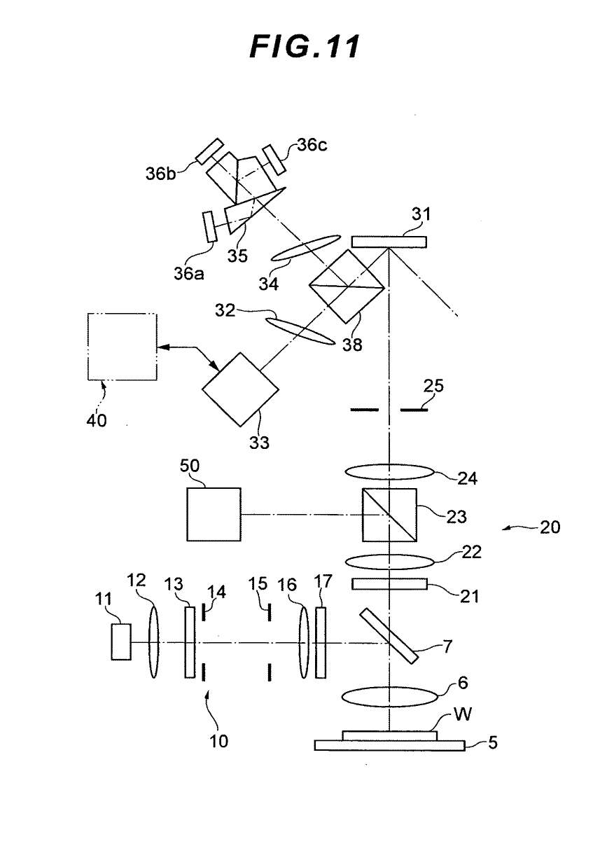

In the above embodiment, the pixel of the DMD element 31, corresponding to the pixel region (divided region) having high sensitivity determined in step S302, is set to the OFF state, so as to guide the reflected light from the wafer W to each detecting element 36a, 36b and 36c, and the other pixels are set to the ON state so as to guide it to the two-dimensional imaging element 33, but the present invention is not limited to this. For example, as FIG. 11 shows, the half prism 38 may be disposed between the DMD element 31 and the lens 32, so that a part of the light traveling from the DMD element 31 to the two-dimensional imaging element 33 is guided from the half prism 38 to each detecting element 36a, 36b and 36c via the lens 34 and the spectral prism 35. In this case, in step S303, the CPU 43 sets the pixel of the DMD element 31 corresponding to a pixel region (divided region) having high sensitivity determined in step S302, to the ON state so as to guide the reflected light from the wafer W to the two-dimensional imaging element 33 and each detecting element 36a, 36b and 36c, and sets the other pixels to the OFF state so as not to guide it to each detecting element 36a, 36b and 36c. As a result, the pixel of the DMD element 31 can be set to the ON state, in which position accuracy is higher, and the light from the wafer W can be guided to each detecting element 36a, 36b and 36c.

In the above mentioned embodiment, the inspecting device 1 for inspecting defects of the wafer W was described as an example, but the inspection target object is not limited to the wafer W, but may be a liquid crystal glass substrate, for example.

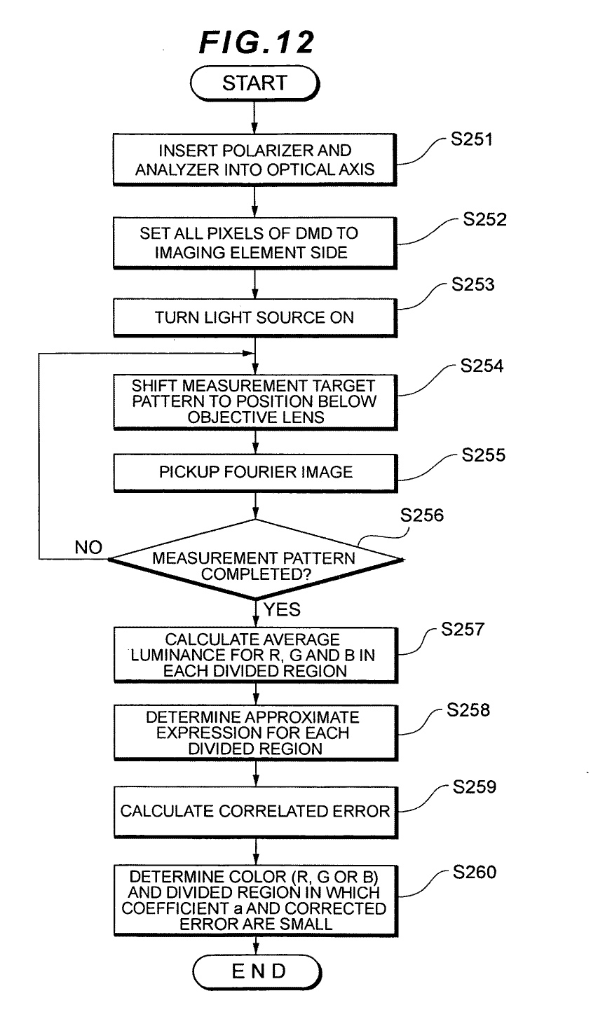

In the above embodiment, a region having high sensitivity to the change of patterns is determined based on the gradation difference data (difference value between the maximum value and the minimum value of the gradation), but the present invention is not limited to this. Now a variant form of a method for determining an area having high sensitivity will be described using a flowchart shown in FIG. 12. In this method, in the same manner as in the above mentioned embodiment, a wafer W, on which a plurality of patterns having a same shape but different exposure conditions (dosage and focus) respectively are formed, is used, and a region having high sensitivity to a change of patterns is determined based on the Fourier image of each pattern and the data on the line width in each pattern. For the data on the line width, a corresponding pattern is measured by a line width measurement unit, such as a scattero-meter and scanning electron microscope (SEM), and it is assumed that the data groups on line width have been input by the input interface 42 and recorded in the recording section 41.

First, in the same manner as in the above mentioned embodiment, the polarizer 17 of the illumination optical system 10 and the analyzer 21 of the detection optical system 20 are inserted into the optical axis in step S251. Then in step S252, all the pixels (micro-mirrors) of the DMD element 31 are set to the ON state, so that all the lights from the wafer W are reflected to the two-dimensional imaging element 33. In the next step S253, the light source 11 of the illumination optical system 10 is turned ON.

In the next step S254, the wafer W, on which a plurality of patterns having a same shape but different exposure conditions (dosage and focus) respectively are formed, is set on the wafer stage 5, and a measurement target pattern (a part of one shot) on the wafer W is moved to a position below the objective lens 6 by the wafer stage 5. In the next step S255, the two-dimensional imaging element 33 picks up the Fourier image and records the picked up Fourier image in the recording section 41.

In the next step, S256, the CPU 43 determines whether measurement is completed for all the patterns on the wafer W. If the result is YES, processing advances to step S257, and if the result is NO, processing returns to step S254, and a pattern (another shot) which has not been measured is moved to a position below the objective lens 6, and the image is picked up in step S255.

In step S257, the CPU 43 generates luminance data (average data) of R (red), G (green) and B (blue) respectively for each divided region of each Fourier image, in the same manner as in the above mentioned embodiment.

In the next step S258, focusing on a same divided region, the CPU 43 determines an approximate expression to indicate a rate of change of the gradation value and the line width of the pattern in a same divided region of each Fourier image FI₁ to FI_{N}, for each color component R, G and B. In concrete terms, when it is assumed that an arbitrary divided region on the Fourier image FI is Pₘ, data on the line width of the pattern corresponding to each Fourier image FI₁ to FIₙ is read from the recording section 41. At this time, the luminance data on each color component (determined in step S257) in the divided region Pₘ is extracted respectively in each Fourier image FI₁ to FIₙ. Then the correspondence of the line width of the pattern and the gradation value of the luminance data in the divided region Pₘ is determined for each Fourier image FI₁ to FIₙ.

Then based on the correspondence of the line width of the pattern and the gradation value in the divided region Pₘ, the approximate expression to indicate a rate of change of the gradation value in the divided region Pₘ and the line width of the pattern is determined by the least square method. The approximate expression is given by the following Expression (1), where y denotes the line width of the pattern corresponding to each Fourier image FI₁ to FIₙ, x denotes a gradation value of B (or R or G) in the divided region Pₘ, a denotes an inclination, and b denotes the y intercept.

y=ax+b (1)

The absolute value of the coefficient a corresponds to the inverse number of the change of gradation with respect to the change of the line width of the pattern (that is, the inverse number of detection sensitivity to the change of patterns). In other words, if the absolute value of the coefficient a decreases, the change of gradation of the Fourier image increases, even if the difference of the line widths is the same, so the detection sensitivity to the change of pattern increases. These steps are executed for each color component, R, G and B, in all the divided regions.

Then in step S259, the CPU 43 determines a correlated error between the approximate expression obtained in step S258 and the line width of the pattern is determined for each color component, R, G and B, in each divided area of the Fourier image. In concrete terms, the CPU 43 calculates the data of deviation between the line width of the pattern corresponding to each Fourier image FI₁ to FIₙ, and the line width of the pattern calculated using the approximate expression for each color component, R, G and B, calculates a standard deviation for each color component in each divided region based on the data on the calculated deviation, and this value is regarded as the correlated error.

Then in step S260, based on the coefficient a determined in step S258 and the correlated error determined in step S259, the CPU 43 determines a divided region in which absolute value of the coefficient a is small and the correlated error is sufficiently small, out of the divided regions of the Fourier image, and determines this divided region as a region having high sensitivity, and determines this as a detection condition. In concrete terms, the CPU 43 scores each divided region based on the value of the absolute value of the coefficient a and the value of the correlated error, and determines the divided region having high sensitivity based on the result of this source. Thus it can be determined which of R, G and B should be used, and which divided region in the Fourier image should be used, in order to detect the line width of the pattern and the change of the profile with high sensitivity.

1. An inspecting apparatus, comprising:
an illuminating section which irradiates illumination light onto a surface of an inspection target substrate;
an optical path switching section which has a plurality of optical path switching elements, and can switch respective reflecting directions of the plurality of optical path switching elements between one direction and another direction;
a two-dimensional image sensor which can detect light from the inspection target substrate onto which the illumination light is irradiated, when the optical path switching elements are oriented in the one direction;
an optical sensor which can detect light from the inspection target substrate onto which the illumination light is irradiated, when the optical path switching elements are oriented in the other direction;
a control section which controls operation of the optical path switching section; and
an inspecting section which inspects the surface of the inspection target substrate based on information obtained by the detection of the optical sensor,
the control section performing control of turning the optical path switching elements to the one direction to determine a part suitable for the inspection out of an inspecting region of the two-dimensional image sensor based on information obtained by the detection of the two-dimensional image sensor, and turning the optical path switching elements corresponding to the determined part suitable for the inspection, to the other direction, and
the inspection section performing the inspection based on information obtained by the detection of the optical sensor in a state where the optical path switching elements corresponding to the part suitable for the inspection are oriented in the other direction.

2. The inspecting apparatus according to claim 1, wherein
the illumination light is linearly polarized light which is irradiated onto the surface of the inspection target substrate having a repeat pattern, and
the two-dimensional image sensor and the optical sensor detect a linearly polarized light component of which polarizing direction is approximately orthogonal to the linearly polarized light, out of the light from the inspection target substrate.

3. The inspecting apparatus according to claim 2, wherein
the illuminating section irradiates the illumination light onto the surface of the inspection target substrate by epi-illumination.

4. The inspecting apparatus according to claim 1, wherein
the information obtained by the detection of the two-dimensional image sensor is luminance information in a Fourier image obtained by the detection of the two-dimensional image sensor.

5. The inspecting apparatus according to claim 1, further comprising a spectral prism which disperses light guided from the optical path switching elements to the optical sensor into a plurality of wavelengths, and
the optical sensor being disposed for each of the plurality of wavelengths obtained by the dispersion by the spectral prism.

6. The inspecting apparatus according to claim 1, wherein
the plurality of optical path switching elements are a plurality of micro-mirrors constituting a digital micro-mirror device.

7. An inspecting method for inspecting a surface of an inspection target substrate, using an inspecting apparatus which has:
an illuminating section which irradiates illumination light onto the surface of the inspection target substrate;
an optical path switching section which has a plurality of optical path switching elements, and can switch respective reflecting directions of the plurality of optical switching elements between one direction and another direction;
a two-dimensional image sensor which can detect light from the inspection target substrate onto which the illumination light is irradiated, when the optical path switching elements are oriented in the one direction; and
an optical sensor which can detect light from the inspection target substrate onto which the illumination light is irradiated, when the optical path switching elements are oriented in the other direction, the inspection method comprising:
a first turning the optical path switching elements to the one direction to determine a part suitable for the inspection out of an inspecting region of the two-dimensional image sensor based on information obtained by the detection of the two-dimensional image sensor; and
a second turning the optical path switching elements corresponding to the part suitable for the inspection, which is determined in the first turning, to the other direction, and performing the inspection based on information obtained by the detection of the optical sensor.

8. The inspecting method according to claim 7, wherein
the illumination light is linearly polarized light which is irradiated onto the surface of the inspection target substrate having a repeat pattern, and
the two-dimensional image sensor and the optical sensor detect a linearly polarized light component of which polarizing direction is approximately orthogonal to the linearly polarized light, out of the light from the inspection target substrate.

9. The inspecting method according to claim 8, wherein
the illumination light is irradiated onto the surface of the inspection target substrate by epi-illumination.

10. The inspecting method according to claim 7, wherein
the information obtained by the detection of the two-dimensional image sensor is luminance information in a Fourier image obtained by the detection of the two-dimensional image sensor.

11. The inspecting method according to claim 7, wherein
in the first turning, a part, in which the luminance change of the detected light based on the change of a surface state of the inspection target substrate is large, is determined as the part suitable for the inspection.

12. The inspecting method according to claim 7, wherein
the second turning comprises dispersing light guided from the optical path switching elements to the optical sensor into a plurality of wavelengths, and
the optical sensor detects light at each of the plurality of wavelengths obtained by the dispersion in the dispersing light.

13. The inspecting method according to claim 7, wherein
the plurality of optical path switching elements are a plurality of micro-mirrors constituting a digital micro-mirror device.

14. An inspecting apparatus, comprising:
an illuminating section which irradiates illumination light onto a surface of an inspection target substrate;
a two-dimensional image sensor which can detect a Fourier image of the inspection target substrate onto which the illumination light is irradiated;
a selective detecting section which detects luminance of a part of the Fourier image and does not detect luminance of the other parts thereof;
a control section which controls operation of the selective detecting section; and
an inspecting section which inspects the surface of the inspection target substrate based on information obtained by the detection of the selective detecting section,
the control section selecting the part to be detected by the selective detecting section based on the information of the Fourier image obtained by the detection of the two-dimensional image sensor.
